(19) United States
(12) Patent Application Publication
(10) Pub. No.: US 2024/0407296 A1
(43) Pub. Date: Dec. 12, 2024

(54) NOVEL TOWING SYSTEM AND METHOD

(71) Applicant: TEVEL ADVANCED TECHNOLOGIES LTD., Modiin (IL)

(72) Inventor: Yaniv MAOR, Modiin (IL)

(21) Appl. No.: 18/697,535

(22) PCT Filed: Sep. 19, 2022
(86) PCT No.: PCT/IL2022/050999

§ 371 Date: Apr. 1, 2024

Related U.S. Application Data
(60) Provisional application No. 63/251,647, filed on Oct. 3, 2021.

(51) Int. Cl. A01D 46/30; B64U 80/86; G05D 1/695; G05D 105/15

(52) U.S. Cl. CPC A01D 46/30; B64U 80/86; G05D 1/695; G05D 2105/15

(57) ABSTRACT

The present invention provides a novel towing system, suitable, e.g., for autonomous harvesting.

### FIELD OF THE INVENTION

The present invention is in the technical field of towing carts, trailers and robots.

### BACKGROUND

When pulling a cart or a trailer, a user faces several problems, such as maneuvering and pulling strength. This means that the towing vehicle has to be strong enough to pull the cart/trailer and the driver needs to know how to maneuver the towing vehicle in order to, e.g., turn the towed cart/trailer.

Another issue is connecting a cart to the towing vehicle and the connecting of one cart to the other. This is a time consuming task that requires skill.

Yet another issue arises when the cart/robot has a built in driving capability, and motors connected to the wheels, which makes towing impossible, thereby forcing the loading of such cart/robot onto an additional cart for towing.

When a single cart/trailer is towed, these and other problems are essentially limited and easily overcome by a skilled driver. However, when two or more carts/trailers are to be towed, these problems are intensified and pose a real issue, that often results in multiple trips at which a single cart/trailer/robot is being towed each time.

Accordingly, a need exists for a more efficient technique and system for pulling multiple carts/trailers/robots by a single towing vehicle and by any driver.

### SUMMARY

The present invention provides a virtual trailer shaft/connection tongue system designed to connect a trailer/cart to a towing vehicle without a physical connection therebetween, while enabling the trailer/cart to automatically follow the towing vehicle/personal (or the cart in front of it), the system comprising: (a) a computing system comprising a memory and a processor; (b) at least one mark designed to be placed on the rear section of the forward vehicle (either the towing vehicle, or a trailer located in front of another trailer); and (c) a detection unit designed to identify said at least one mark and transmit to said computing system data regarding the position, distance and location of said at least one mark relative to the detection unit, wherein said computing system determines, based on said data, the position of the trailer relative to the forward vehicle (or forward cart), and based thereon instruct the trailer whether to move forward, backwards or to completely stop, and whether to turn left or right.

In specific embodiments, the system further comprises (d) a maneuvering system designed to transmit the direction of the wheels of the trailer to the computing system, which in turn uses such data to control the trailer's wheels' direction thereby enabling the trailer to follow the towing vehicle or the trailer in front.

The present invention further provides trailers equipped with such virtual trailer shaft/connection tongue system.

The present invention assumes that the cart has a built-in self-driving mechanism, which can be electrical driving. The towing according to the present invention can also be by autonomous driving, meaning that the towing vehicle is operated by autonomous driving. Notably, since autonomous driving for carts is very complex and requires massive processing capabilities, the present invention focuses mainly on the connectivity between the towing vehicle and the cart (and between one cart to the other), while referring mainly to a manual driven/operated towing vehicle—this is a hybrid model: self-driving of each towed cart which are led by a person or manual activated tractor.

### BRIEF DESCRIPTION OF THE DRAWINGS

FIG. 1 is an illustration of today's trailers' connection technique/system.

FIG. 2 is a computerized illustration of the trailers' connection system of the present invention.

FIGS. 3A-3B are illustrations of various embodiments of the trailers' connection system of the present invention.

FIGS. 4A-4B illustrate specific usages of the trailers' connection system of the present invention in harvesting.

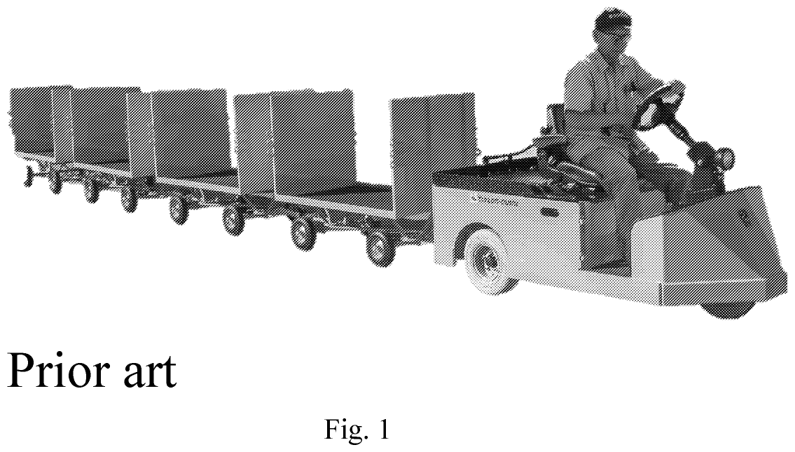

### DETAILED DESCRIPTION

Selecting the right trailer/cart/robot is determined according to various conditions and uses. Whether it is needed to haul a truck, building materials, all-terrain vehicles or anything else, there's a specific trailer size and type that best suits the specific needs.

Basically, determining the required/possible trailer's size requires knowing: the gross vehicle weight rating (GVWR) of the towing vehicle, wherein the bigger the towing vehicle, the larger and heavier trailer it can tow; determining the specific or broad needs, i.e. what is towed? driving distance, maneuvering complexity, etc.

Today, when towing a cart/trailer, the trailer is usually equipped with only two wheels or four wheels positioned in close proximity to one another in order to allow easy maneuvering of the trailer. However, in such configurations the wheels are usually positioned at the rear section of the trailer or essentially at its center, which result with lower stability of the cart/trailer when it's not connected to the towing vehicle, thereby requiring the use of a stabling leg. An alternative, more stable configuration is a trailer equipped with three or four wheels spread evenly along the trailer's body designed to provide sufficient support for the trailer when standing alone. However, if the front wheel(s) are fixed and not steerable, this configuration dramatically reduce maneuverability of the trailer during towing.

Another problem today is the weight limitations, namely that the towing vehicle is limited to towing a very specific weight, meaning that it is impossible to tow more weight than recommended otherwise the vehicle will be damaged. This limits the towing capabilities in terms of both the trailer's weight and the number of trailers that can be towed. When a cart is self-driving (i.e. has its own motor), its weight is even higher and this limitation is even harder (as in cases where the cart is a self-operated robot that needs to be towed to a plantation to work).

The tongue and hitch system pose another issue. Each trailer has its own hitch system, which requires a specific anchoring point at the towing vehicle. Height differences between the towing vehicle and the trailer add to the connection problem. These points make it hard to replace towing vehicles and/or mix different trailers with different towing vehicles without prior preparation and adaptation.

As to the connection tongue/shaft, it is a pole that is connected between the towing vehicle and the trailer. The rigidity of the pole and other anchoring components associated therewith adds difficulty to the maneuvering during the towing of the trailer. For instance, when longer tongue/pole is used, which is often required due to the width of the trailer/towing-vehicle, the turning radius grows.

The above points demonstrate the problems arising during towing. These problems are increased tenfold when towing multiple trailers, especially in a hard-maneuvering terrain, such as when towing multiple carts in an orchard, e.g. for harvesting.

Accordingly, the present invention provides a cart/trailer and towing system that overcome all the above and other problems.

In a first aspect, the present invention provides a virtual trailer shaft/connection tongue for connecting one or more trailers/carts to a towing vehicle. The virtual connection tongue comprises a computing system comprising a memory and a processor, at least one mark designed to be placed on the rear section of the forward vehicle (either the towing vehicle, or a trailer located in front of another trailer), and a detection unit designed to identify said at least one mark and transmit to the computing system data regarding the position, distance and location of the at least one mark relative to the detection unit, wherein the computing system determines, based on such data, the position of the trailer relative to the forward vehicle, and based thereon instruct the trailer whether to move forward, backwards or to completely stop, and whether to turn left or right.

In specific embodiments, the system further comprises (d) a maneuvering system designed to transmit the direction of the wheels of the trailer to the computing system, which in turn uses such data to control the trailer's wheels' direction thereby enabling the trailer to follow the towing vehicle or the trailer in front.

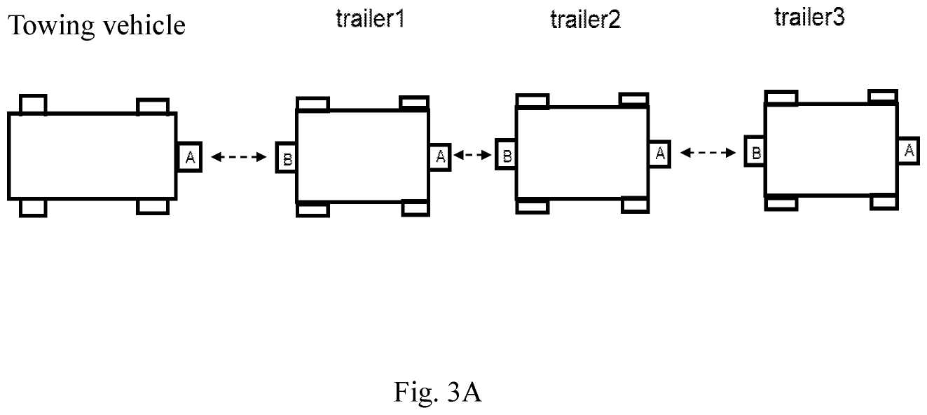

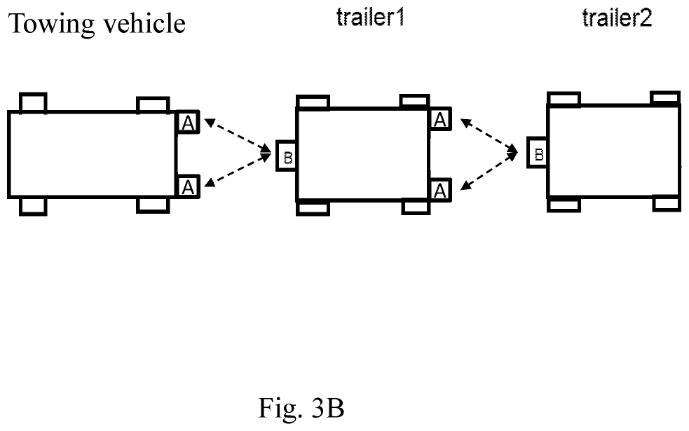

In specific embodiments, the system of the invention comprises 1, 2, 3 or more marks positioned along the rear section of the leading vehicle, either the towing vehicle or the rear section of a trailer that is followed by another trailer. FIG. 3A illustrates the use of a single mark and a single detection unit. The use of multiple marks enables a more accurate determination of the position of the leading vehicle relative to the following trailer. For instance, and as illustrated in FIG. 3B, if the leading vehicle is equipped with two marks, each one located at a different rear corner thereof, the identification that the detection unit is closer to one mark relative to its distance from the other mark would be indicative that the trailer is drifting in the direction of the closer mark (or that the leading vehicle is turning), and would initiate corrective measures to direct the trailer to the correct path/position behind the leading vehicle. An alternative option is that the leading vehicle comprises 3 marks: one in the middle and the other two in opposite rear corners of the vehicle, wherein identification of one of the corner marks by the identification unit would be interpreted as drifting of the trailer or turning of the leading vehicle, and would initiate corrective measures to direct the trailer to the correct path/position behind the leading vehicle. In specific embodiments, the system comprises more than one detection unit.

Any type of mark can be used. Non-limiting examples of suitable marks are: visual sticker; light source including visible light, IR and laser; barcode; RFID; NFC; 2D barcode; radio transmitter, Aruco codes, barcodes tags, or any other communication means, or any combination thereof. Naturally, the detection unit is designed to identify the selected mark and/or receive data therefrom, and can be, e.g., a camera, a 3D-camera, a laser measure, a barcode reader, etc. As illustrated in FIGS. 3A & 3B, module “A” illustrates the mark(s), and module “B” illustrates the detection unit.

In a second aspect, the present invention provides a virtual trailer shaft/connection tongue for connecting one or more trailers/carts to a towing vehicle mounted onto a towing vehicle and one or more trailers designed to be towed by the towing vehicle. Accordingly, in certain embodiments, the present invention provides a towing vehicle and one or more trailers designed to be towed thereby equipped with the virtual trailer shaft/connection tongue system of any of the embodiments above.

Notably, in order for a trailer to be able to follow the towing vehicle (or the trailer in front of it) while having route-adjustment capabilities that enable it to correct its route in accordance with that of the leading vehicle, without being physically connected thereto, the trailer has to be equipped with an independent engine, such as an electric or combustion engine, and with a stirring mechanism to enable it maneuvering, wherein the computing system controls both based on data received from the detection unit(s). Accordingly, in certain embodiments, the present invention provides a towing vehicle/personal and a trailer(s) equipped with the virtual trailer shaft/connection tongue system of any one of the preceding embodiments, wherein said trailer is a self-driving trailer that comprises an autonomous engine and a stirring mechanism, and wherein said computing system controls both according to data received from the detection unit.

Accordingly, in certain embodiments, the trailers according to any of the embodiments above further comprise at least one autonomous energy pack/power source for powering up and/or charging the at least one engine and any other component, such as the computing system. In certain embodiments, the trailer further comprises a solar energy collection module for charging the energy pack and/or the electric components in the trailer.

In certain embodiments, each trailer is equipped with a computing system of its own, making it completely autonomous. In alternative embodiments, a single computing system is designed to receive data from detection units located on several trailers, and thus controls all such trailers, thereby reducing costs of the overall system by using a single computing system. In such a case, the virtual trailer shaft/connection tongue system according to any of the embodiments above further comprises data transmitters to enable the detection units to send data to said computing system, which may be located on the towing vehicle.

In certain embodiments, trailers according to any of the embodiments above comprise a computing system that enables them to be completely independent/autonomous so that there is no need for a manual control. In specific embodiments, this computing system is the same computing system as that of the virtual trailer shaft/connection tongue system. In further or alternative embodiments, the computing system also controls the robotic harvester.

In specific embodiments, the trailers and towing vehicles of the invention are designated for agriculture. In further specific embodiments, for harvesting. Even more specifically, for autonomous harvesting using harvesting robots, and optionally robotic towing vehicle towing robotic trailers according to the present invention.

When harvesting with ground-moving harvester robots, the robots usually carry their own collection bin(s) and fill it as they move through the tree lines.

Such manual or robotic harvesting it time consuming and costly since it usually requires either a long harvesting time or numerous harvesters. For example, a 500-hectare farm, with 9000 lines of trees, the length of each line is about 180 meters, needs to be picked within 60 days. Accordingly, it is required to harvest 150 tree lines per day to complete the picking on time. In modern orchards, the number of bins in such a line is about 18, so that the distance between two adjacent bins is approximately 10 meters. The density and number of bins is dependent on the fruit density and on the quality of selective harvesting. The picking rate of a ground harvesting robot with 6 harvesting arms is about one line per day, which means that about 150 tractors or vehicles equipped with such harvesting robot are required to operate the farm, along with about 8 forklifts for collecting the full bins.

Accordingly, in certain embodiments the towing vehicle can be a tractor or other suitable vehicle that can move in an orchard, and the trailers can be selected from any one of: a fruit collection bin, a harvesting cart carrying robotic harvesting arm or unmanned aircraft harvesting vehicles (UAVs), and a fruit selection unit, or any combination thereof. In certain embodiment, a single tractor tows one or more collection bins and one or more harvesting carts, wherein either the bins or the harvesting carts are optionally equipped with a fruit selection unit.

Accordingly, in a third aspect, the present invention provides a harvesting system for autonomous harvesting fruits in an orchard, the system comprising a towing vehicle and at least one trailer equipped with the virtual trailer shaft/connection tongue system according to any of the embodiments above, wherein the at least one trailer is equipped or carries at least one robotic harvesting arm or unmanned aircraft harvesting vehicles (UAVs).

In specific embodiments, the above system comprises two or more trailers, wherein at least one of said trailers is equipped or carries at least one robotic harvesting arm or UAVs, and at least one of said trailers is a fruit collection bin. In further specific embodiments, these at least one trailer is equipped with a fruit selection unit.

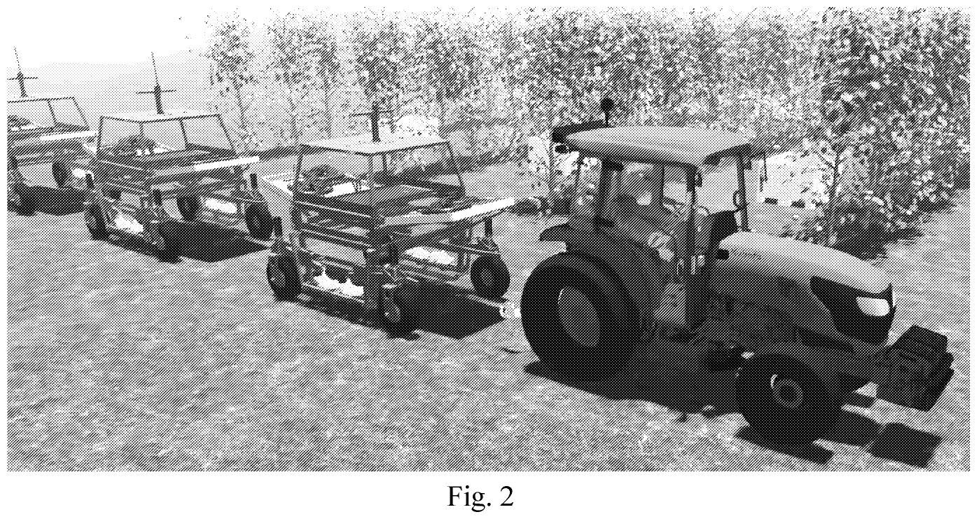

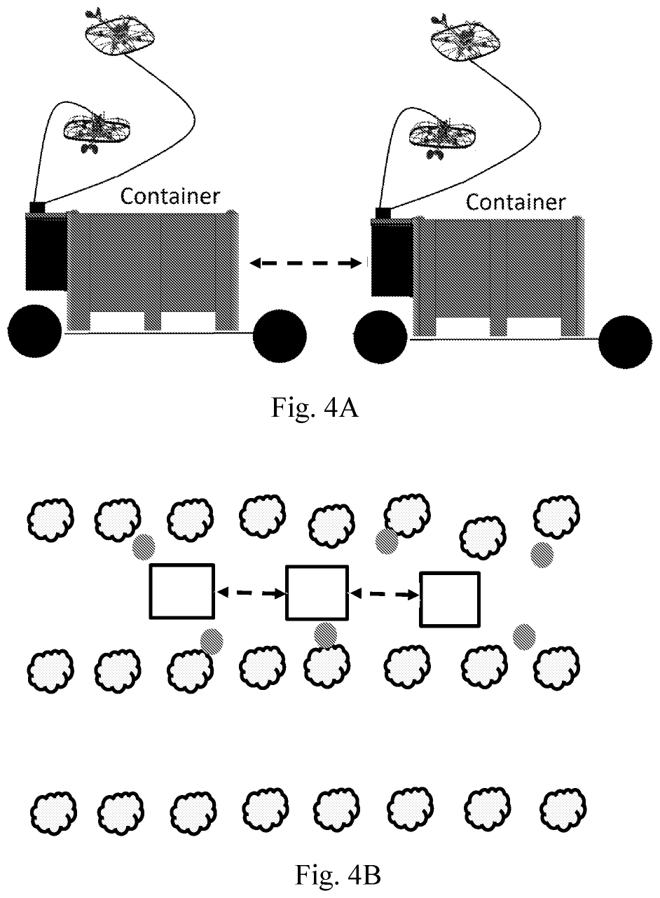

FIGS. 4A & 4B illustrate trailers that are fruit collection bins equipped with harvesting UAVs, wherein the trailers are connected to one another using the virtual trailer shaft/connection tongue system according to any of the embodiments above, enabling easily towing any number of trailers inside an orchard even after the collection bins have been filled with harvested fruits. FIG. 2 illustrates trailers that are fruit collection bins equipped with harvesting UAVs on one side and with a fruit selection unit on their other side, wherein the trailers are connected to one another using the virtual trailer shaft/connection tongue system according to any of the embodiments above.

The terms “collection bin” or “bin” as used herein interchangeably, refers to a container for collecting fruits, which is a portable bin with or without wheels and mounted on wheels, such as a collection wagon that can be used either as individual wagons that can be dispersed in an orchard, or as a train of wagons that is pulled together into and out of an orchard (with the virtual trailer shaft/connection tongue system of the invention). Notably, the wagons can be pulled together, disconnect and dispersed in several locations in the orchard, and reconnect back to a train once filled for removal from the orchard.

Accordingly, harvesting systems of the invention, that include a towing vehicle and a train of collection bins equipped with harvesting robot(s), enable to reduce the number of large machinery vehicles that is required for harvesting an orchard since a single tractor (or two) may be sufficient to pull and deploy all the bins in the orchard in a short period of time, and eventually also for collecting all the filled bins. Such a system can be used to tow and deploy various harvesting robots (and collection bins) along the lines within an orchard, and from that point the harvesting robots can pick fruits autonomously. In specific embodiments, such harvesting robots are equipped with an autonomous maneuvering capabilities and can drive within the orchard lines autonomously.

In certain embodiments of the harvesting system of the invention, the harvesting robots are installed on the collection bin, i.e. using a dedicated vessel/box holding the harvesting robots. In alternative or added embodiments, the system includes individual bins and individual units holding the harvesting robots.

In certain embodiments of the harvesting system of any of the embodiments above, the robotic harvester is a: (a) robotic harvesting arm that is connected to the frame/box that includes a power source, or (ii) flying unmanned aircraft harvesting vehicle (UAV), which is either flying wirelessly or is wirely connected to the frame/box.

It should be noted that the number of robotic harvesters, either flying ones or not, within the harvesting system of the invention may vary according to need and desire. For instance, there can be 1, 2, 3, 4, 5, 6, 7, 8, 9, 10 or more robotic harvesters.

In certain embodiment of the harvesting system of the invention, the harvesting robot is a UAV equipped with one or more harvesting arms that are designed to harvest fruits in the bin's surroundings at a radius of up to 5 meters or tree-top or more, up to 10 meters or more; up to 15 meters or more, up to 20 meters or more, or about 30 meters or more.

In certain embodiment of the harvesting system of the invention, the harvesting robot is a threaded UAV that receives energy wirely from a power source located/installed in the frame or box mounted/attached on the collection bin/wagon-bin.

1. A virtual trailer shaft/connection tongue system designed to connect a trailer/cart to a towing vehicle without a physical connection therebetween, while enabling the trailer/cart to automatically follow the towing vehicle (or the cart in front of it) the system comprising:
a) a computing system comprising a memory and a processor;
b) at least one mark designed to be placed on the rear section of the forward vehicle (either the towing vehicle, or a trailer located in front of another trailer); and
c) a detection unit designed to identify said at least one mark and transmit to said computing system data regarding the distance and location of said at least one mark relative to the detection unit,
wherein said computing system determines, based on said data, the position of the trailer relative to the forward vehicle, and based thereon instruct the trailer whether to move forward, backwards or to completely stop, and whether to turn left or right.

2. The system of claim 1, further comprising a maneuvering system designed to transmit the trailer's wheels' direction to said computing system.

3. The system of claim 1, wherein said at least one mark is 1, 2, 3 or more marks positioned along the leading vehicle's rear section.

4. The system of claim 1, wherein said at least one mark is selected from: visual sticker; light source including visible light, IR and laser; barcode; RFID; NFC; 2D barcode; radio transmitter, or any other communication means, or combinations thereof; and said detection unit is designed to identify said mark and/or receive data therefrom.

5. The system of claim 4, wherein a single mark is used and said detection unit is a 3D-camera that is capable of measuring the direction and distance from said single mark.

6. The system of claim 4, wherein two or more marks are used, and said detection unit is a 2D-camera that is capable of measuring the direction and distance from said two or more marks.

7. A towing vehicle/personal and a trailer equipped with the virtual trailer shaft/connection tongue system of claim 1, wherein said trailer comprises an autonomous engine and a stirring mechanism, and wherein said computing system controls both. is equipped with a self-driving capability that can interface with the detection unit

8. The trailer of claim 7 which is a harvesting cart carrying robotic harvesting arm or unmanned aircraft harvesting vehicles (UAVs).

9. A harvesting system for autonomous harvesting comprising at least one towing vehicle and at least one trailer equipped with the virtual trailer shaft/connection tongue system of claim 1, wherein said at least one trailer is equipped or carries at least one robotic harvesting arm or unmanned aircraft harvesting vehicles (UAVs).

10. The harvesting system of claim 9, comprising two or more trailers, wherein at least one of said trailers is equipped or carries at least one robotic harvesting arm or UAVs, and/or at least one of said trailers is a fruit collection bin.
